(19) United States
(12) Patent Application Publication
(10) Pub. No.: US 2009/0144044 A1
(43) Pub. Date: Jun. 4, 2009

(54) Logic simulator and logic simulation method

(75) Inventors: Yasushi Wataya, Kanagawa (JP); Toshihiro Ueda, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/292,794

(22) Filed: Nov. 26, 2008

(30) Foreign Application Priority Data
Nov. 30, 2007 (JP) 2007-309904

(51) Int. Cl. G06F 17/50

(52) U.S. Cl. 703/15

(57) ABSTRACT

A logic simulator includes a storage device and a simulator part. The storage device stores a signal duration delay file which associates first signal duration information indicating duration of an input signal supplied to a logic gate of a logic circuit with first element delay value information indicating a first element delay value. The simulator part extracts first element delay value information associated with the first signal duration information corresponding to second signal duration information indicating duration of an input signal supplied to the logic gate when a logic simulation is performed by referring the signal duration delay file, and performs the logic simulation of the logic circuit based on the extracted first element delay value information. By setting element delay value taking duration of an input signal into account, highly accurate logic simulation can be achieved.

### INCORPORATION BY REFERENCE

This Patent Application is based on Japanese Patent Application No. 2007-309904. The disclosure of the Japanese Patent Application is incorporated herein by reference.

### BACKGROUND OF THE INVENTION

1. Field of the Invention

The present invention relates to a logic simulator and logic simulation method for simulating a logic operation of a semiconductor integrated circuit.

2. Description of Related Art

In developments of semiconductor integrated circuits, a logic simulator that finds failures in an early stage of logic design plays a very important role. Logic simulators which perform logic simulation based on delay on a logic circuit are widely used. In recent years, along with increases in degree of integration and size of semiconductor integrated circuits, a highly accurate logic simulation has been strongly demanded to achieve higher-speed operations. There exist various logic simulation methods. For example, in Japanese Patent No. 2723019 (or corresponding unexamined Japanese Laid-Open Patent Application JP-A-Heisei 07-182382), which is referred to as the patent document 1 in the following, a method for estimating an element delay time and an interconnection delay time is proposed.

FIG. 1 illustrates a configuration of a logic simulator described in the patent document 1. The logic simulator is provided with a logic description part 1, a compiler 2, a delay library 3, a delay calculation part 4, a delay file 5, a logic description object part 6, a simulator part 7, and a simulation result 8. The logic description part 1 stores a description of a verification target logic circuit. The compiler 2 converts the logic description stored in the logic description part 1 into an object format. The delay library 3 registers a plurality of pieces of delay coefficient data used for interconnection delay value calculation. The delay coefficient data corresponds to each of a plurality of logic gates in a logic circuit, and also to the load capacitance of each of the output terminals of the logic gates. Further, the delay coefficient data corresponds to each of supply states of a plurality of input signals of each of the logic gates. The delay calculation part 4 calculates a plurality of interconnection delay values which vary dependently on supply of the pluralities of pieces of delay coefficient data and load capacitances. The interconnection delay values are registered in the delay file 5. In the logic description object part 6, objects that are the compiled description contents stored in the logic description part 1 summated with interconnection delay values supplied from the delay file 5 are registered. Objects are supplied to the simulator part 7. The simulator part 7 further sets a delay time for an output signal of the verification target gate to perform a logic simulation. The simulation result 8 stores the result of the simulation.

Further, the logic description object part 6 is provided with an input definition part for defining the output logic and the delay time of the logic gate. The input definition part defines the output logic and the delay time of the logic gate. The output logic and the delay time of the logic gate correspond to each of supply states of the plurality of input signals supplied to a plurality of input terminals of each of the logic gates constituting the logic circuit.

FIG. 2 is a block diagram of the logic description object part 6. The logic description object part 6 is provided with an F/I table 6-1, an F/O table 6-2, a logic table 6-3, an element delay table 6-4, and an interconnection delay table 6-5. The F/I table 6-1 registers therein a name of a logic gate that is an input signal supply source and a name of an input terminal. The F/O table 6-2 registers therein a name of a logic gate that is an output signal supply destination and a name of an output terminal. The logic table 6-3 stores an output value determined by states f(IN1, IN2, . . . ) of input terminals. The element delay table 6-4 stores a delay value specific to a circuit element of each of the logic gates. The delay value specific to the circuit element varies depending on the states f(IN1, IN2, . . . ) of input terminals. The interconnection delay table 6-5 registers therein an interconnection delay value corresponding to an output terminal of each of the logic gates. The interconnection delay value varies depending on the states f(IN1, IN2, . . . ) of input terminals.

The logic description part 1 is compiled by the compiler 2. The compiled logic description is added with the delay file 5, and then registered in the logic description object part 6. In the delay file 5, the interconnection delay values for respective states (f(IN1, IN2, . . . )) of the input terminals are registered on a functional output terminal basis. The interconnection delay value TD in the delay file 5 is obtained by multiplying delay coefficient data R and an output load capacitance CL for a verification target gate in the delay calculation part 4. The delay coefficient data R is supplied from the delay library 3. The output load capacitance CL is supplied from the logic description part 1. In the delay library 3, the delay coefficient data for each of the states (f(IN1, IN2, . . . )) of the input terminals is defined on each functional output terminal. If, in the delay library 3, N types of delay coefficient data R1 to RN corresponding to N types of input states are defined, the delay file 5 registers therein N types of interconnection delay values TD1 to TDN.

Next, referring to FIG. 3, an operation in a reference example is described. In the logic simulator of the patent document 1, when a variation in some input signal occurs at time t=0 (hereinafter referred to as an “event”. The same is true in the case of a variation in an output signal.) (Step P1), the event is extracted (Step P2). Then, the event is transmitted (Step P3), and a logic operation is performed (Step S4). Further, a delay time is set (Step S5), and the event is registered (Step P6). Subsequently, the determination whether or not the simulation is ended is made (Step P7). In the logic operation (Step 54), the states f(IN1, IN2, . . . ) (hereinafter referred to as f(INi)) of input signals other than the input signal is first checked on the basis of the F/I table 61 (Step S4-1). Then, on the basis of the logic table 63, an element delay value Di and an interconnection delay value TDi corresponding to the state f(INi) are selected (Step S4-2). The element delay value Di and the interconnection delay value TDi are summated (Step S4-3), and the sum (Di+TDi) is set as the delay time (Step S5). The event registration (Step P6) is performed after the time (Di+TDi) has elapsed.

As described above, the logic simulator of the patent document 1 produces an effect capable of simulating with high accuracy a CMOS composite gate circuit, or the like, in which an interconnection delay value varies according to a supply state of a plurality of input signals.

### SUMMARY

The above-described patent document 1 achieves that a plurality of delay values are provided according to the supply state of input signals at input terminals. That is, on a basis of delay path information (information indicating which of the input terminals at which a variation in an input signal determines a variation in an output signal at an output terminal of each of the plurality of logic gates of the verification target logic circuit), the element delay value Di corresponding to the supply state f(INi) of input signals is adapted to be selected from the logic table 6-3 and the element delay table 6-4. Then, the selected element delay value Di and the interconnection delay value TDi are summated with each other to be set as a delay time.

However, the present inventor has focused on a fact that the element delay value is influenced not only by the supply state of input signals but also by signal durations indicating the durations of input signals. The signal duration is hereinafter referred to as an “input width”. The input width indicates duration from the occurrence of a variation in a supplied input signal to the next variation of the signal at each of a plurality of input terminals of a plurality of logic gates of the verification target logic circuit. That is, the input width represents a transition timing interval of an input signal.

In recent years, a semiconductor integrated circuit has been operated at higher speed, and influence of the input width on the delay value has been larger, so that a logic simulation taking into account the influence has been needed. However, in the patent document 1, the influence of the input width of the input signal is not taken into account.

FIG. 4 is a diagram illustrating an example of the device operation in which the relationship between an input width and an element delay value is illustrated. A horizontal axis represents the input width W (ns). A vertical axis represents the element delay value D (ns) We assume that if the input width is large enough not to influence the device, the element delay value of the device becomes a constant value of 1 ns. That is, “1 ns” represents the element delay value without taking the input width into account. “W1” in the diagram indicates a range of the duration where the input width is less than 1 ns. “W2” indicates a range of the duration where the input width is larger than 1 ns. It turns out from FIG. 4 that in the W2 range where the input width is large enough not to influence the device, the element delay value takes a constant value of 1 ns. However, it also turns out that in the W1 range, the element delay value has different characteristics depending on the magnitude of the input width. This phenomenon should be taken into account in device in recent years having higher operation speed. The technique described in the patent document 1 cannot deal with a logic simulation involving a plurality of device delay values dynamically varying depending on an input width. That is, the technique of the patent document 1 has a problem of being unable to reproduce an actual device operation precisely, and also unable to deal with designing of a product including operations in which element delay values dynamically vary.

In a first aspect of the present invention, a logic simulator includes a storage device and a simulator part. The storage device stores a signal duration delay file which associates first signal duration information indicating duration of an input signal supplied to a logic gate of a logic circuit with first element delay value information indicating a first element delay value. The simulator part extracts first element delay value information associated with the first signal duration information corresponding to second signal duration information indicating duration of an input signal supplied to the logic gate when a logic simulation is performed by referring the signal duration delay file, and performs the logic simulation of the logic circuit based on the extracted first element delay value information.

A logic simulator according to the present invention can set an element delay value taking into account the influence of an input width. That is, even in a situation where the element delay value varies depending on the input width, a highly accurate logic simulation can be performed.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a logic simulator shown in the patent document 1;

FIG. 2 is a block diagram of a logic description object part 6 that is one of components of the logic simulator shown in the patent document 1;

FIG. 3 is a flowchart illustrating a processing operation of the logic simulation in the patent document 1;

FIG. 4 is a graph illustrating a relationship between an input width and an element delay value;

FIG. 5 is a block diagram illustrating an example of a hardware configuration in a logic simulator and logic simulation according to an embodiment of the present invention;

FIG. 6 is a block diagram illustrating a logic simulator according to a first embodiment of the present invention;

FIG. 7A is a timing chart illustrating an input width of an input signal at an input terminal;

FIG. 7B is a timing chart illustrating an input width of an input signal at an input terminal;

FIG. 7C is a timing chart illustrating an input width of an input signal at an input terminal;

FIG. 8 is a diagram illustrating a configuration example of an input width delay file F1 of a logic simulator according to a first embodiment of the present invention;

FIG. 9 is a graph illustrating an example of a relationship between an input width and an element delay time;

FIG. 10 is a diagram illustrating a configuration of a simulator part 200-1 of the logic simulator according to an embodiment of the present invention;

FIG. 11 is a diagram illustrating a configuration of a logic operation part 231 of the simulator part 200-1 in the logic simulator according to an embodiment of the present invention;

FIG. 12 is a flowchart illustrating a processing operation of a logic simulator according to an embodiment of the present invention;

FIG. 13 is a flowchart illustrating details of the processing operation of a logic simulator according to an embodiment of the present invention;

FIG. 14 is a block diagram illustrating a logic simulator according to a second embodiment of the present invention;

FIG. 15 is a diagram illustrating a configuration example of a delay file F2 of a logic simulator according to a second embodiment of the present invention;

FIG. 16 is one symbol diagram for configuring the delay file F2;

FIG. 17 is a diagram illustrating a configuration of a logic operation part 232 of a simulator part 200-2 in the logic simulator according to an embodiment of the present invention;

FIG. 18 is a flowchart illustrating a processing operation of a logic simulator according to a second embodiment of the present invention;

FIG. 19 is a flowchart illustrating details of the processing operation of a logic simulation according to a second embodiment of the present invention;

FIG. 20 is a block diagram illustrating a logic simulator according to a third embodiment of the present invention;

FIG. 21 is a diagram illustrating a configuration example of a delay condition file F3 of a logic simulator according to a third embodiment of the present invention;

FIG. 22 is a diagram illustrating a configuration of a logic operation part 233 of a simulator part 200-3 in a logic simulator according to an embodiment of the present invention; and

FIG. 23 is a flowchart illustrating a processing operation of a logic simulator according to a third embodiment of the present invention.

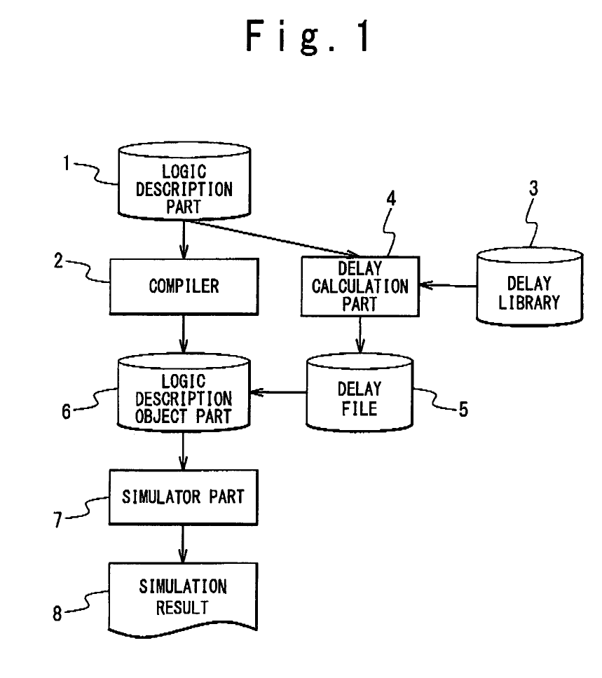

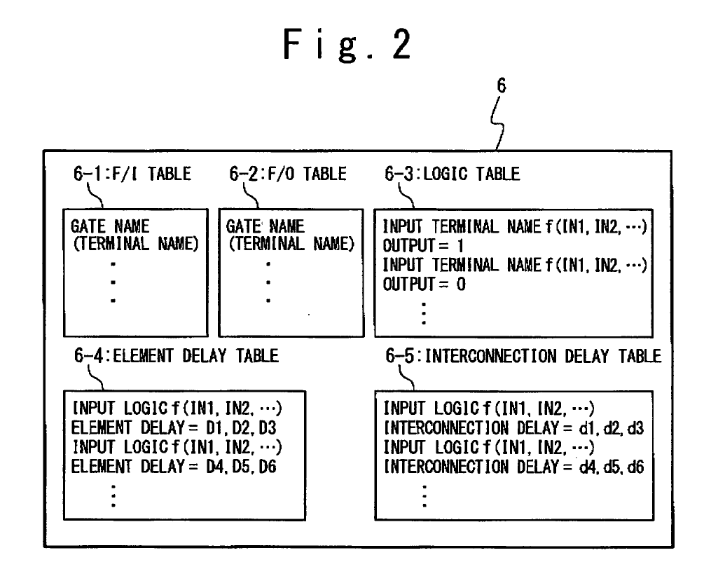

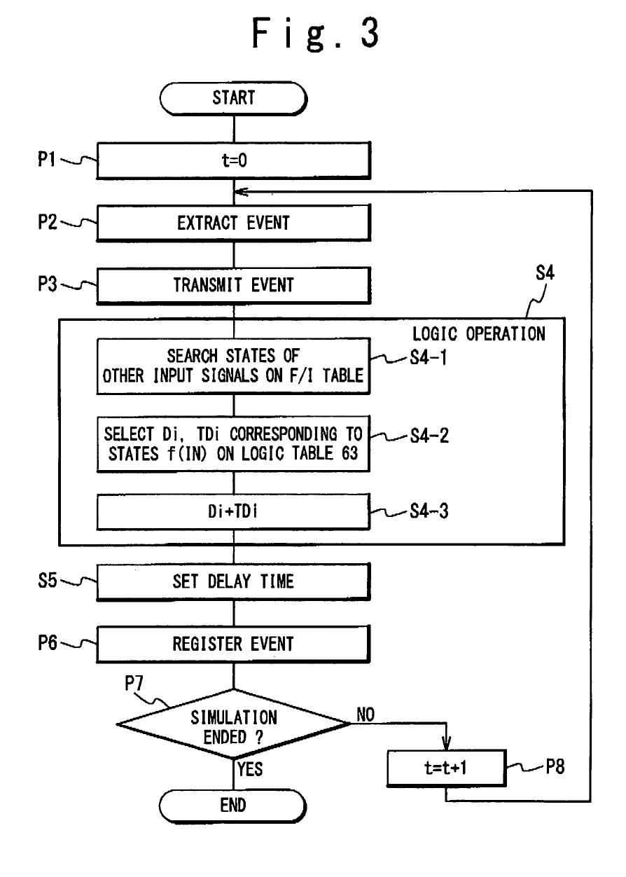

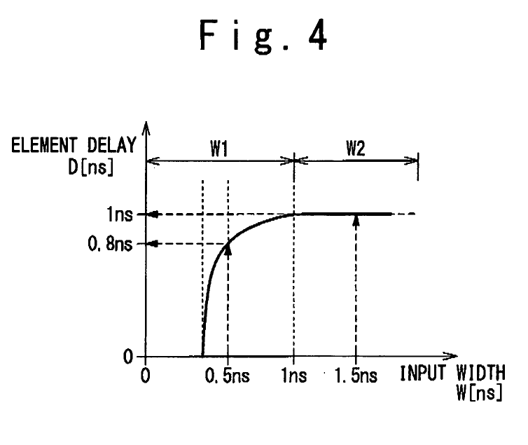

### DESCRIPTION OF THE PREFERRED EMBODIMENTS

Hereinafter, a logic simulator and a logic simulation method according to embodiments of the present invention will be described with reference to the attached drawings.

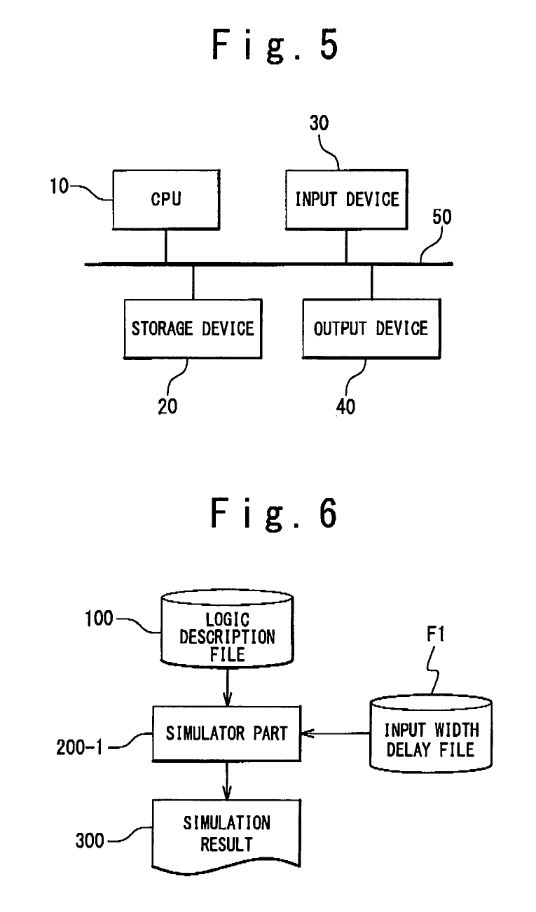

FIG. 5 is a block diagram illustrating an example of a hardware configuration in an embodiment of a logic simulator of the present invention. As illustrated in FIG. 5, a logic simulator according to an embodiment of the present invention operates on a computer system provided with; a CPU (Central Processing Unit) 10; a storage device 20 including a hard disk, memory and the like; an input device 30 including a keyboard and a mouse; an output device 40 such as a display, and a bus 50 for connecting the respective devices to one another.

The CPU 10 performs calculation processing and control processing associated with a logic simulator according to embodiments of the present invention stored in the storage device 20. The storage device 20 stores therein respective functions and means related to embodiments of the present invention in a format executable by the CPU 10 such as a computer program read from a computer-readable recording medium such as the CD-ROM or DVD, or a computer program inputted from the input device 30. Also, the storage device 20 is used as a work area upon calculation by the CPU 10.

FIG. 6 is a block diagram illustrating a first-embodiment that is one example of a logic simulator of the present invention. The logic simulator of a first embodiment determines, on a basis of an input width of an input signal at an input terminal, an element delay value for each of logic gates of a verification target logic circuit which is to be simulated. The input width is information on a signal duration representing duration of an input signal. The input width represents a time interval between a signal variation in a supplied input signal and the next signal variation at each of a plurality of input terminals of a plurality of logic gates of the verification target logic circuit. That is, the input width represents a transition timing interval of the input signal.

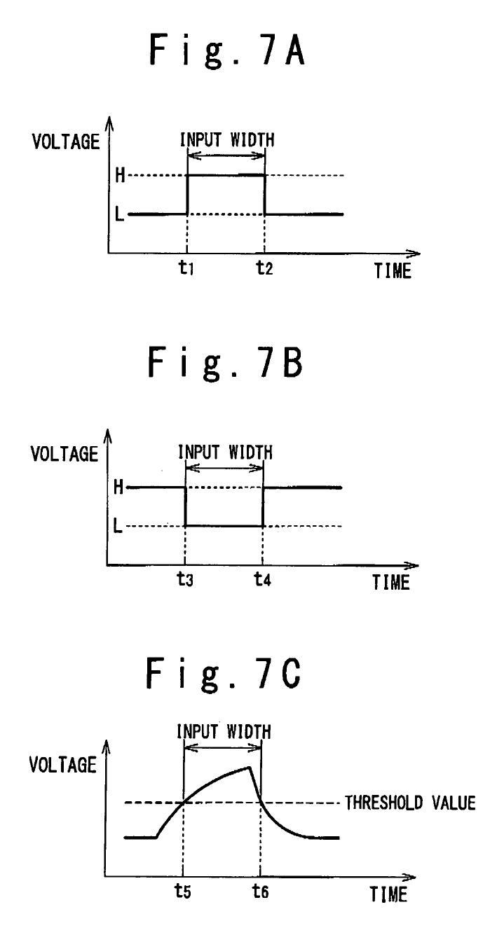

FIG. 7A to 7C are one example of a time chart illustrating the input width. The input width in FIG. 7A represents a time interval from a rise time (t1) to a fall time (t2) in terms of voltage variation of an input signal. An input width in FIG. 7B represents a time interval from a fall time (t3) to a rise time (t4) in terms of voltage variation of an input signal. In a present embodiment, any of the input widths in FIGS. 7A and 7B are assumed to be acceptable. FIG. 7C illustrates an example of a distorted waveform that is not an ideal waveform. The input width for this case represents a time interval from a rise variation time (t5) to a fall variation time (t6) in terms of voltage variation of an input signal. FIG. 7C illustrates that any threshold value can be set for calculating the input width.

The logic simulator of this embodiment determines an interconnection delay value on a basis of a supply state of an input/output signal. The sum of the obtained element delay value and interconnection delay value is defined as the delay value of the verification target logic circuit. The supply state of an input/output signal represents voltage, temperature, various process variations appearing through manufacturing processing and the like.

The logic simulator of this embodiment includes a logic description file 100, an input width delay file F1, a simulator part 200-1, and a simulation result 300. A signal duration delay file associating the input signal duration and the element delay value with each other is referred to as an input width delay file F1. These are stored in the storage device 20. Information on input signal transmission and information on an input signal associated with the simulation are stored in the logic description file 100.

The logic description file 100 represents a logic description of the verification target logic circuit. The simulator part 200-1 extracts logic description, a supply state of an input/output signal, a load capacitance and the like from the logic description file 100. The input width delay file F1 stores mathematical formula information (including a fixed value) representing a plurality of pieces of element delay value information for every plurality of logic gates. These pieces of element delay value information correspond to a magnitude of an input width of an input signal at an input terminal. The magnitude of the input width is classified in terms of a range of duration of the input signal.

The simulator part 200-1 obtains from the input width delay file F1 the mathematical formula information (including a fixed value) representing the element delay value information corresponding to a logic gate of the verification target logic circuit. Also, the simulator part 200-1 determines en element delay value for each of the plurality of gates of the verification target logic circuit. Further, the simulator part 200-1 determines an interconnection delay value. For example, similarly to the technique found in the patent document 1, the interconnection delay value is obtained by calculating delay coefficient data and a load capacitance. There exist a plurality of pieces of delay coefficient data corresponding to supply states of the plurality of input signals at the plurality of input terminals and a supply state of an output signal. The supply state of the input/output signal indicates voltage, temperature, various process variations appearing through manufacturing processing and the like. The load capacitance is provided from the logic description file 100. As a method for obtaining the delay coefficient data, any of a method in which an external file of the simulator part 200-1 is referred to similarly to the patent document 1 and a method in which the delay coefficient data is preliminary stored in the simulator part 200-1 can be adopted. The sum of the determined element delay value and the interconnection delay value is set to the delay value (Di+TDi). The simulator part 200-1 sets the delay value (Di+TDi) for information on the output signal at the output terminal to perform the logic simulation. The simulation result 300 stores therein a result of the simulation.

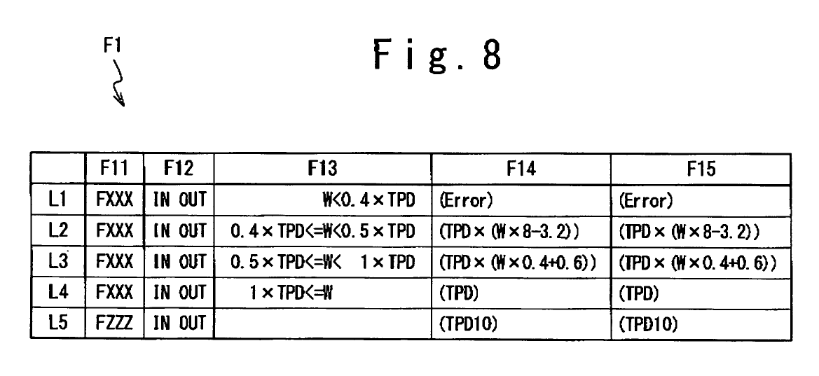

FIG. 8 is a diagram illustrating a configuration example of the input width delay file F1. The logic simulator of this embodiment defines the input width delay file F1 taking a concept regarding time, i.e., input width, into a condition of delay variation. The input width delay file F1 defines element delay value information associated with the input width for each of the logic gates and also for each of pieces of delay path information.

The input width delay file F1 is provided with a block name F11, delay path information F12, input width range information F13, and mathematical formula information (including a fixed value) F14 and F15 representing element delay value information. The block name F11 represents a name of a logic gate of the verification target logic circuit. That is, the input width delay file F1 stores a plurality of logic gates (block name F11). The delay path information F12 indicates which of input terminals at which a variation in input signal determines a variation in output signal at an output terminal. That is, the delay path information F12 represents a correspondence relationship between variation in an input signal at an input terminal and an output signal at an output terminal. The input width delay file F1 stores a plurality of pieces of delay path information F12. The input width range information F13 indicates a range of the input signal duration. The mathematical formula information (including a fixed value) F14 or F15 representing the element delay value information corresponds to the input width range information F13, and is information for calculating the element delay value. The calculated element delay value is set for information on an output signal at an output terminal when the logic simulation is performed. “W” present in the input width range information F13, or mathematical formula information F14 or F15 representing the element delay value information represents an input width of an input signal at an input terminal. The input width calculated in logic simulation is assigned to W. TPD (ns) present in F14 or F15 represents the element delay value information for a case where an input width after the circuit is stabilized is large enough, and corresponds to a case where the element delay value information is given by a numerical value. TPD (ns) and TPD10 have values specific to each of the logic gates (block name F11) and each of the pieces of delay path information F12.

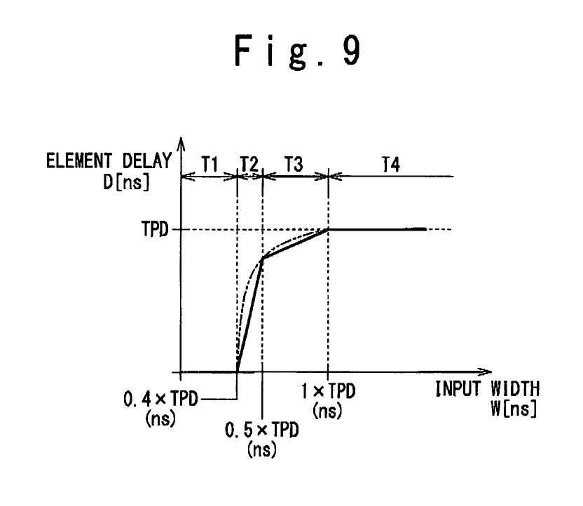

FIG. 9 is a graph illustrating an example of a relationship between the input width and the element delay value in FIG. 8. The horizontal axis represents the input width W (ns). The vertical axis represents the element delay value D (ns). TPD (ns) represents the element delay value after the circuit is stabilized.

The input width range indicated by T1 represents that a variation in input signal at an input terminal does not reach a threshold voltage because an input width is too short, and therefore there is no output variation that can be taken as a signal variation in an actual device operation. In the example of FIG. 9, T1 is defined as a range less than 0.4×TPD (ns), and the corresponding element delay value is defined as Error. In FIG. 8, the input width range of T1 is indicated by L1. Also, the element delay values (F14 and F15) are defined as Errors.

An input width range indicated by T2 represents a range from the input width where the variation in input signal at an input terminal is equal to or more than the threshold voltage to the input width where the element delay value is less than TPD×0.8 (ns) In an example of FIG. 9, T2 is defined as the range equal to or more than 0.4×TPD (ns) and less than 0.5×TPD (ns). In FIG. 8, an input width range of T2 is indicated by L2, and the element delay value is given by a mathematical formula. The mathematical formula representing the element delay value approximates the element delay value, which is varied depending on the magnitude of the input width, by a linear line closely representing the device operations. By assigning an actually calculated input width to the mathematical formula, a more accurate element delay value taking into account the input width can be determined.

The input width range indicated by T3 represents a range from the input width where the element delay value is equal to or more than TPD×0.8 (ns) to the input width where the element delay value is less than TPD (ns) at which the circuit is stabilized. In the example of FIG. 9, T3 is defined as the range equal to or more than 0.5×TPD (ns) and less than TPD (ns) In FIG. 8, the input width range of T3 is indicated by L3. Similarly to T2, the mathematical formula representing the element delay value approximates the element delay value, which is varied depending on the magnitude of the input width, by a linear line closely representing a device operation. By assigning an actually calculated input width to the mathematical formula, a more accurate element delay value taking into account the input width can be determined.

The input width range indicated by T4 represents a range where the element delay value is constant after the circuit is stabilized. In the example of FIG. 9, T4 is defined as the range equal to or more than 1×TPD (ns). In FIG. 8, the input width range of T4 is indicated by L4. The element delay value is constant in device operation to be achieved, and therefore determined to be a numerical value of TPD even in the logic simulation.

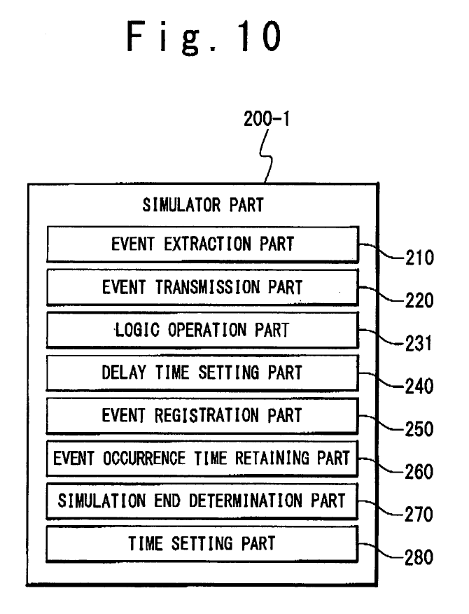

FIG. 10 is a diagram illustrating a configuration of the simulator part 200-1.

The simulator part 200-1 is provided with an event extraction part 210, an event transmission part 220, a logic operation part 231, a delay time setting part 240, an event registration part 250, an event occurrence time retaining part 260, a simulation end determination part, and a time setting part 280.

Upon occurrence of a variation in an input signal at an input terminal, the event extraction part 210 extracts the input signal as an event for each of the logic gates of the verification target logic circuit. The input signal is provided for a simulation from the logic description file 100.

The event transmission part 220 transmits the extracted event. Information on the transmission is included in the logic description file 100. The event transmission part 220 provides logic gate information, delay path information and the like associated with the simulation to the logic operation part 231 on the basis of the logic description file 100.

The logic operation part 231 determines an element delay value and an interconnection delay value for each of the logic gates. The logic operation part 231 further summates the element delay value and the interconnection delay value each other to determine a delay value for each of the logic gates of the verification target logic circuit. The element delay value is determined depending on the magnitude of the input width of the input signal at the input terminal. The interconnection delay value is determined corresponding to a supply state of an input/output signal.

The delay time setting part 240 sets the delay value determined in the logic operation part 231 for each of the logic gates of the verification target logic circuit.

The event registration part 250 registers the transmitted event.

The event occurrence time retaining part 260 retains an event occurrence time.

The simulation end determination part 270 determines the end of the logic simulation.

The time setting parts set the event occurrence time t=0 and adds 1 to t (t=t+1), if the logic simulation is not ended.

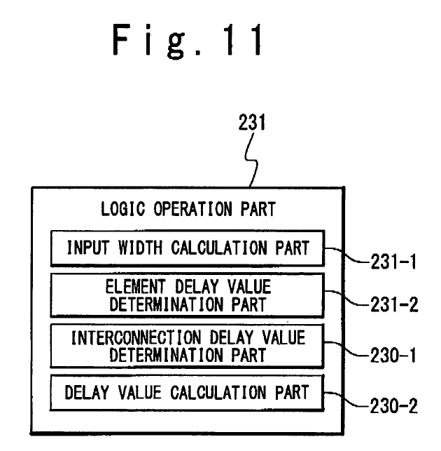

FIG. 11 is a diagram illustrating a configuration of the logic operation part 231.

The logic operation part 231 includes an input width calculation part 231-1, an element delay value determination part 231-2, an interconnection delay value determination part 230-1, and a delay value calculation part 230-2.

The input width calculation part 231-1 calculates an input width on the basis of an input signal at an input terminal.

The element delay value determination part 231-2 determines an element delay value from the input width delay file F1 on the basis of the element delay value information associated with the calculated input width. The element delay value information is given by the mathematical formula information (including a fixed value). If the information is given by a numerical value (fixed value), the value is treated as the element delay value. If the information is given by a mathematical formula, the calculated value is determined as the element delay value.

The interconnection delay value determination part 230-1 obtains an interconnection delay value by a calculation using delay coefficient data and a load capacitance. The interconnection delay value corresponds to supply states of a plurality of input signals respectively supplied to a plurality of input terminals. Regarding the delay coefficient data, there exist a plurality of pieces of delay coefficient data corresponding to supply states of a plurality of input signals at a plurality of input terminals and the supply state of the output signal. The supply state of the input/output signal indicates voltage, temperature, various process variations appearing through manufacturing processing and the like. As a method for obtaining the delay coefficient data, any of a method in which an external file of the simulator part 200-1 is referred to similarly to the patent document 1 and a method in which the delay coefficient data is preliminary stored in the simulator part 200-1 can be adopted. The load capacitance is provided from the logic description file 100.

The delay value calculation part 230-2 summates the determined element delay value and interconnection delay value, and determines the sum as the delay value of the logic gate of the verification target logic circuit.

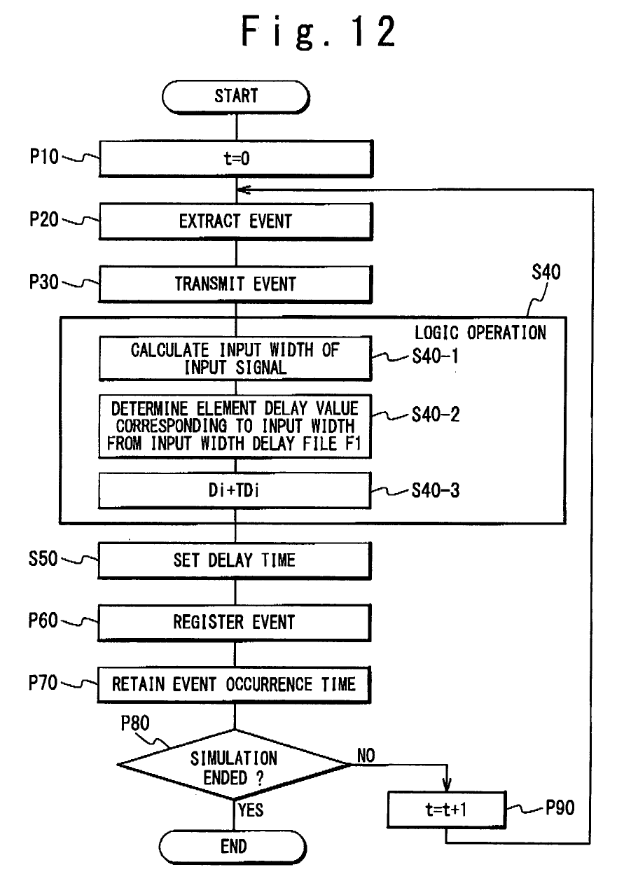

FIG. 12 is a flowchart illustrating a processing operation of a logic simulator of an embodiment of the present invention.

At time t=0, when a variation in an input signal at some input terminal of a logic gate occurs (hereinafter referred to as an “event”. The same is true in the case of a variation in an output signal.) (Step P10), the event extraction part 210 extracts the input signal as an event (Step P20). The input signal is provided for a simulation from the logic description file 100. The event transmission part 220 transmits the extracted event (Step P30). Information on the transmission is included in the logic description file 100. The event transmission part 220 provides the logic gate information (block name F11), delay path information F12 and the like associated with the simulation to the logic operation part 231 on the basis of the logic description file 100.

The logic operation part 231 determines a delay value for each of the logic gates (Step S40). The delay value for each of the logic gates is obtained as follows: first, the input width calculation part 231-1 obtains an input width of the input signal on the basis of the logic gate information (block name F11), input width range information F13 and the like provided from the logic description file 100 (Step S40-1). Then, the element delay value determination part 231-2 determines an element delay value corresponding to the input width from the input width delay file F1 for each of the logic gates on the basis of the delay path information F12 and the like provided from the event transmission part 220 (Step S40-2). Further, the interconnection delay value determination part 230-1 calculates an interconnection delay value on the basis of the delay coefficient data and load capacitance.

Subsequently, the delay value calculation part 230-2 summates the element delay value and the interconnection delay value, and determines the sum as the delay value for each of the logic gates (Step S40-3). The delay time setting part 240 sets the delay value determined in the logic operation part 231 for an output signal as a delay time (Step S50). The event registration part 250 registers the event having occurred in the simulator 200-1 (Step P60). The event occurrence time retaining part 260 retains the event occurrence time in the simulator 200-1 (Step P70). The simulation end determination part 270 determines the end of the logic simulation (Step P80). If it is determined in the logic simulation end determination processing that the logic simulation is not ended, the time t is added with 1 (Step P90). The case where the logic simulation is not ended refers to a state where not all signals for the logic simulation provided from the logic description file 100 are inputted/outputted.

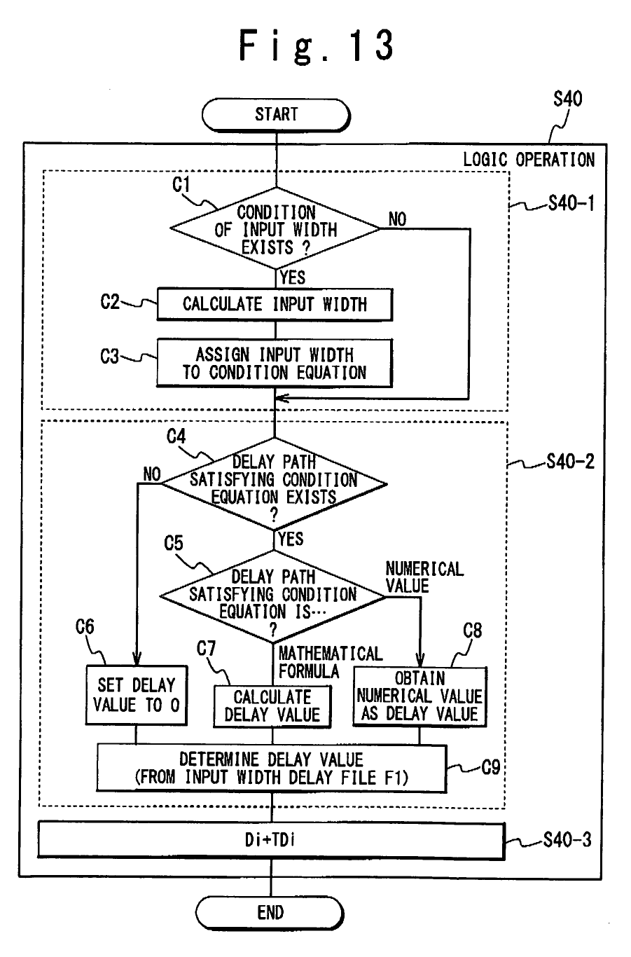

FIG. 13 is a diagram illustrating an operation of the logic operation part 231 in more detail.

Details of steps in which the input width calculation part 231-1 calculates an input width of the input signal (Step S40-1), the element delay value determination part 231-2 determines the element delay value based on the input width (Step S40-2), interconnection delay value determination part 230-1 determines the interconnection delay value on the basis of the input state of the input signal, and the delay value calculation part 230-2 summates the determined element delay value and the interconnection delay value to determine the delay value of the verification target logic gate (Step S40-3) are described.

Step S40-1 is described. The input width calculation part 231-1 determines whether or not the input width range information F13 (input width condition) on the input signal detected as the event is present in the input width delay file F1 on the basis of the logic gate information (block name F11) provided from the event transmission part 220 (Step C1). If the input width condition is present, the input width calculation part 231-1 calculates the input width based on the time difference between the occurrence time of the previous event and the present event (Step C2) If the input width condition is not present, the next step (Step S40-2) is performed. The input width calculation part 231-1 refers to the input width delay file F1 corresponding to the target logic gate. Then, the obtained input width W is assigned to the input width range information F13 in the input width delay file F1 (Step C3). The input width range information F13 represents the mathematical formula information (including a fixed value) F14 or F15 representing element delay information varies depending on the magnitude of the input width.

Next, Step S40-2 is described. The element delay value determination part 231-2 searches the delay path information F12 corresponding to the input width range information F13 in the input width range information F13 assigned with the input width W by the input width calculation part 231-1 (Step C4). Even if there is no input width range information F13 (input width condition) in the above-described input width calculation part 231-1, the delay path information F12 is searched (Step C4). The element delay value determination part 231-2 determines the element delay value to be 0 if the delay path information F12 is not present (Steps C6 and C9).

The element delay value determination part 231-2 determines whether or not the mathematical formula information (including a fixed value) F14 or F15 representing the element delay value information corresponding to the delay path information F12 relevant to the input width range information F13 is given by a mathematical formula or a numerical value (fixed value) (Step C5). If it is given by a mathematical formula, the element delay value determination part 231-2 determines the calculated value of the mathematical formula assigned with the input width W as the element delay value (Steps C7 and C9) (L1, L2 and L3 in FIG. 8). If it is given by a numerical value, the numerical value is determined as the element delay value (Steps C8 and C9) (L4 in FIG. 8). If there is no input width range information F13 and the delay path information F12 is set, the numerical value (fixed value) is determined as the element delay value (L5 in FIG. 8).

Next, Step S40-3 is described. The interconnection delay value determination part 230-1 calculates the interconnection delay value corresponding to a supply state of an input/output signal. The delay value calculation part 230-2 summates the element delay value which is determined in the element delay value determination part 231-2 and the interconnection delay value which corresponds to the supply state of the input/output signal and is calculated in the interconnection delay value determination part 230-1, and determines the sum as the delay value of each of the logic gates.

The logic simulator in patent document 1 cannot represent that the dependence of the element delay value on the variation in the input width of an input signal as illustrated in FIG. 9. The logic simulator of this embodiment of the present invention incorporates the input width in a condition of delay variation, and defines the mathematical formula information (fixed value) representing the element delay value information in the input width delay file F1. That is, the logic simulator of this embodiment obtains a mathematical formula information (including a fixed value) representing the element delay value information from the input width delay file F1 for each of input widths of each of the logic gates, and thereby can perform a logic simulation of a logic circuit more accurately than before.

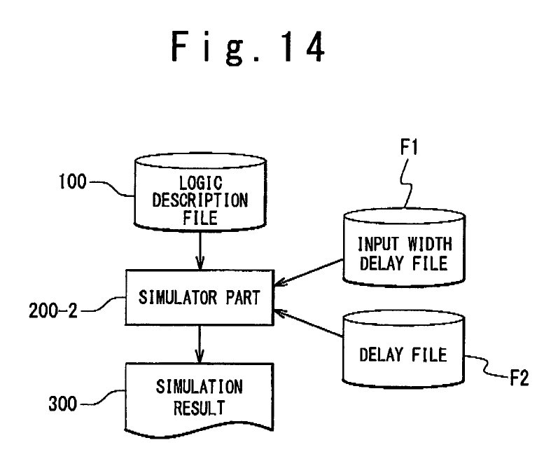

FIG. 14 is a block diagram illustrating a second embodiment of the present invention.

In a second embodiment, a delay file F2 is further added to the logic simulator of a first embodiment. A supply state delay file associated with supply states of a plurality of input signals at a plurality of input terminals and fixed element delay information is referred to as the delay file F2. In a second embodiment, it is achieved that an element delay value can be selected on a basis of an element delay value, which is based on an input width set in the input width delay file F1, and the fixed element delay value information, which is set in the delay file F2 and based on the supply states of the plurality of input signals at the plurality of input terminals.

The logic simulator of a second embodiment includes the logic description file 100, the input width delay file F1, the delay file F2, the simulator part 200-2, and the simulation result 300. These components are stored in the storage device 20. Regarding the logic simulator of a second embodiment, the logic description file 100, the input width delay file F1, and the simulation result 300 are configured in the same manner as in a first embodiment.

The logic description file 100 represents a logic description of a verification target logic circuit. The simulator part 200-2 extracts a logic description, a supply state of an input/output signal, a load capacitance and the like from the logic description file 100. The input width delay file F1 retains mathematical formula information (fixed value) representing a plurality of pieces of element delay value information depending on the magnitude of an input width, for each of a plurality of logic gates and each piece of delay path information. The delay file F2 includes a plurality of pieces of fixed element delay value information respectively specific to the plurality of logic gates. These pieces of fixed element delay value information correspond to supply states of input signals at verification target input terminals of the logic gate. Further, these pieces of fixed element delay value information include fixed element delay value information corresponding to respective supply states of a plurality of input signals at a plurality of input terminals other than the input signal at the verification target input terminal of the simulation performed by the logic simulator among the plurality of input terminals included in the logic gate, which is called as adjacent supply state information.

The simulator part 200-2 obtains the mathematical formula information (including fixed element delay value information) representing the element delay value information from the input width delay file F1 and the delay file F2. The simulator part 200-2 calculates the element delay value for each of the plurality of logic gates of the verification target logic circuit. Further, the simulator part 200-2 calculates an interconnection delay value on a basis of pieces of delay coefficient data corresponding to the supply states of a plurality of input/output signals at a plurality of input/output terminals and a load capacitance provided from the logic description file 100. As a method for obtaining the delay coefficient data, any of a method in which an external file of the simulator part is referred to and a method in which the delay coefficient data is preliminary stored in the simulator part 200-2 can be adopted similarly to a first embodiment. Still further, the simulator part 200-2 sets the delay value (Di+TDi), which is obtained by summating the determined element delay value and the interconnection delay value, for output signal information to perform a logic simulation. The simulation result 300 stores therein a result of the simulation.

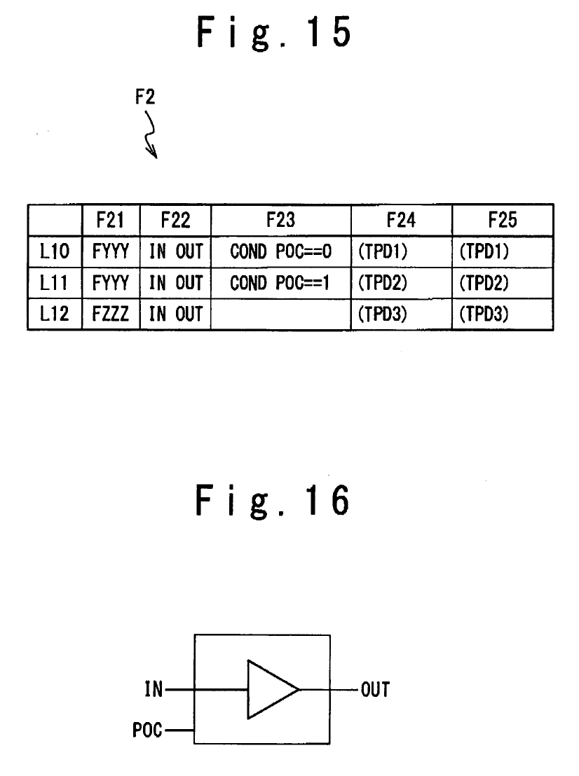

FIG. 15 is a configuration example of the delay file F2 in a second embodiment.

The delay file F2 is provided with a block name F21, delay path information F22, supply state condition equation F23, and fixed element delay value information F24 and F25. The block name F21 represents the name of a logic gate of the verification target logic circuit. The delay path information F22 indicates which of input terminals at which a variation in input signal determines a variation in output signal at an output terminal. That is, the delay file F2 stores a plurality of logic gates (block name F21) and a plurality of pieces of delay path information F22. The delay file F2 is referred to corresponding to a supply state of an input signal. The supply state condition equation F23 represents each of the supply states of the plurality of input signals at the plurality of input terminals other than the input signal at the verification target input terminal among the plurality of input terminals included in the logic gate. The fixed element delay value information F24 or F25 represents a fixed element delay value corresponding to the supply state condition equation F23.

FIG. 16 is a symbol diagram for configuring the delay file F2 in a second embodiment of the present invention. The symbol diagram includes a virtual terminal POC, which is not directly relevant to the logic, as an input terminal. That is, the delay file F2 represents that each of the supply states of the plurality of input signals at the plurality of input terminals other than the input signal at the verification target input terminal among the plurality of input terminals included in the logic gate can be taken into account. L10 in FIG. 15 represents that the element delay value for a case where the signal state of the input terminal POC is “0” can be set. Similarly, L11 represents that the element delay value for a case where the signal state of the input terminal POC is “1” can be set. Note that each of “0” and “1” represents one example of the supply state of an input signal. TPD1 and TPD2 in the fixed element delay value information F23 and F24 represent element delay values that are fixed values different from each other.

Regarding the simulator part 200-2, the logic operation part 231 in the simulator part 200-1 is replaced by the logic operation part 232. The rest is the same as that of the configuration in FIG. 10.

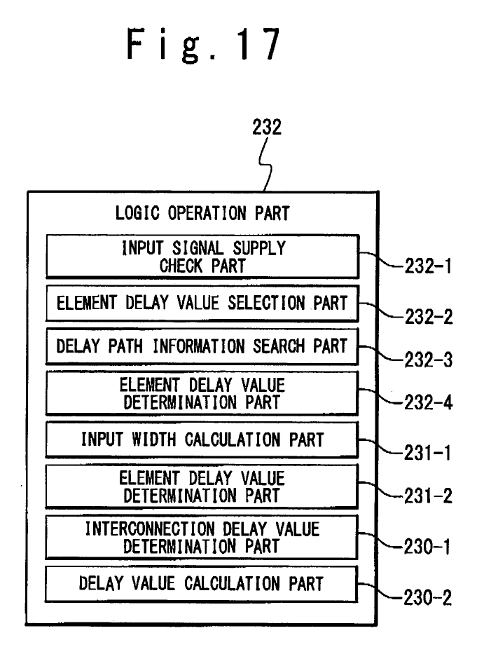

FIG. 17 is a diagram illustrating a configuration of the logic operation part 232.

The logic operation part 232 is provided with an input signal supply check part 232-1, an element delay value selection part 232-2, a delay path information search part 232-3, an element delay value determination part 232-4, an input width calculation part 231-3, an element delay value determination part 231-2, an interconnection delay value determination part 230-1, and a delay value calculation part 230-2.

The input signal supply check part 232-1 checks supply states of input signals at all input terminals of the verification target logic gate on the basis of logic gate information, delay path information and the like provided from the event transmission part 220. The input signal supply check part 232-1 refers to the delay file F2 corresponding to the supply state of the input signal of the verification target logic gate. The element delay value selection part 232-2 selects fixed element delay value information on the logic gate from the delay file F2 on a basis of the supply state of the verification target input signal. The delay path information search part 232-3 searches the delay path information corresponding to the input signal from the delay file F1 on the basis of the logic gate information, the delay path information and the like provided from the event transmission part 220. The element delay value determination part 232-4 determines, if corresponding delay path information is absent in the delay path information search part 232-3, the fixed element delay value information selected from the delay file F2 as the element delay value. If corresponding delay path information is present in the delay path information search part 232-3, processing by the input width calculation part 232-1 and the element delay value determination part 231-2 determines an element delay value on the basis of the mathematical formula information representing the element delay value information. The delay value calculation part 230-2 summates the determined element delay value and an interconnection delay value based on the interconnection delay value determination part 230-1, similarly to the first embodiment, to calculate the delay value.

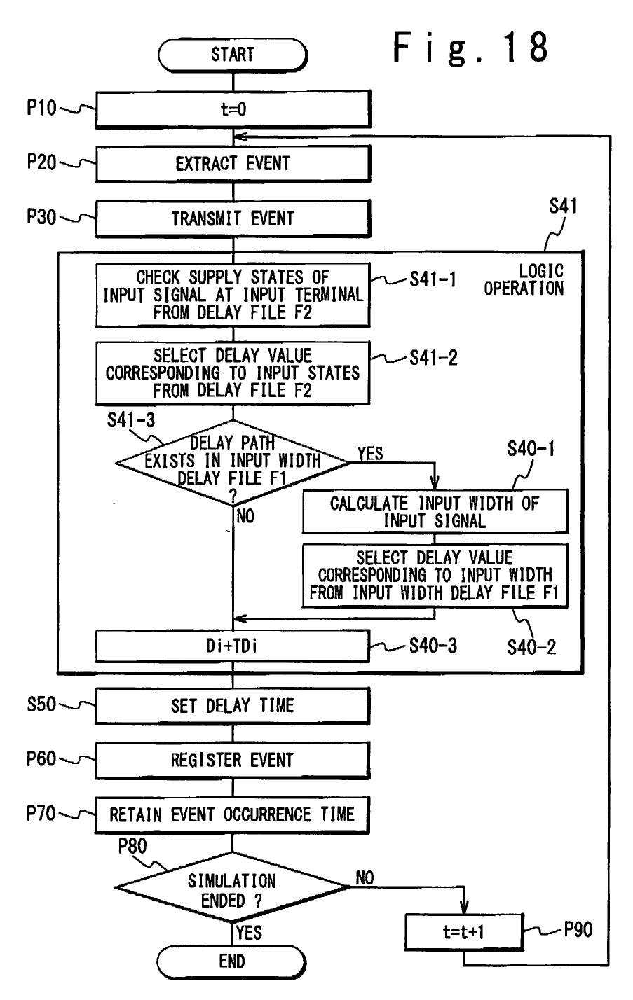

FIG. 18 is a flowchart illustrating a processing operation performed by the logic simulator in a second embodiment of the present invention. In this embodiment, a logic operation (Step S41) is different as compared with that of a first embodiment. The rest is the same as that in a first embodiment. An input signal is provided for the simulation from the logic description file 100. The event transmission part 220 transmits an extracted event (Step P30). Information on the transmission is included in the logic description file 100. The event transmission part 220 provides, on the basis of the logic description file 100, the logic gate information (block name F11 or F21), the delay path information F12 or F12 and the like associated with the simulation to the logic operation part 232.

The logic operation part 232 determines a delay value for each logic gate (Step S41). The input signal supply check part 232-1 checks the supply states of the input signals at all of the input terminals of the verification target logic gate (Step S41-1). The input signal supply check part 232-1 refers to the delay file F2 corresponding to a supply state of an input signal of the verification target logic gate. The element delay value selection part 232-2 refers to the delay file F2 to select the fixed element delay value information F24 or F25 (Step S41-2). The fixed element delay value information F24 and F25 are selected based on the each supply state of the input signal at the verification target input terminal and each of supply states of a plurality of input signals at a plurality of input terminals other than the input signal at the verification target input terminal among input terminals included in the logic gate. The delay path information search part 232-3 determines, on the basis of the logic gate information (block name F11), delay path information F12 and the like provided from the event transmission part 220, whether or not the delay path information F12 corresponding to the input signal is present in the input width delay file F1 (Step S41-3). If the delay path information F12 is present, the mathematical formula information (including a fixed value) F14 and F15 representing the element delay value information based on an input width is calculated, similarly to a first embodiment, and determined as the element delay value of the verification target logic circuit (Steps S40-1 and 540-2). If the delay path information F12 is not present in the input width delay file F1, the element delay value determination part 232-4 determines the fixed element delay value information F24 or F25 selected from the delay file F2 as the element delay value of the verification target logic gate.

The delay value calculation part 230-2 summates the element delay value determined on the basis of the input width delay file F1 or the delay file F2 and the interconnection delay value determined in the interconnection delay value determination part 230-1 (Step S40-3). The subsequent operation is the same as in a first embodiment.

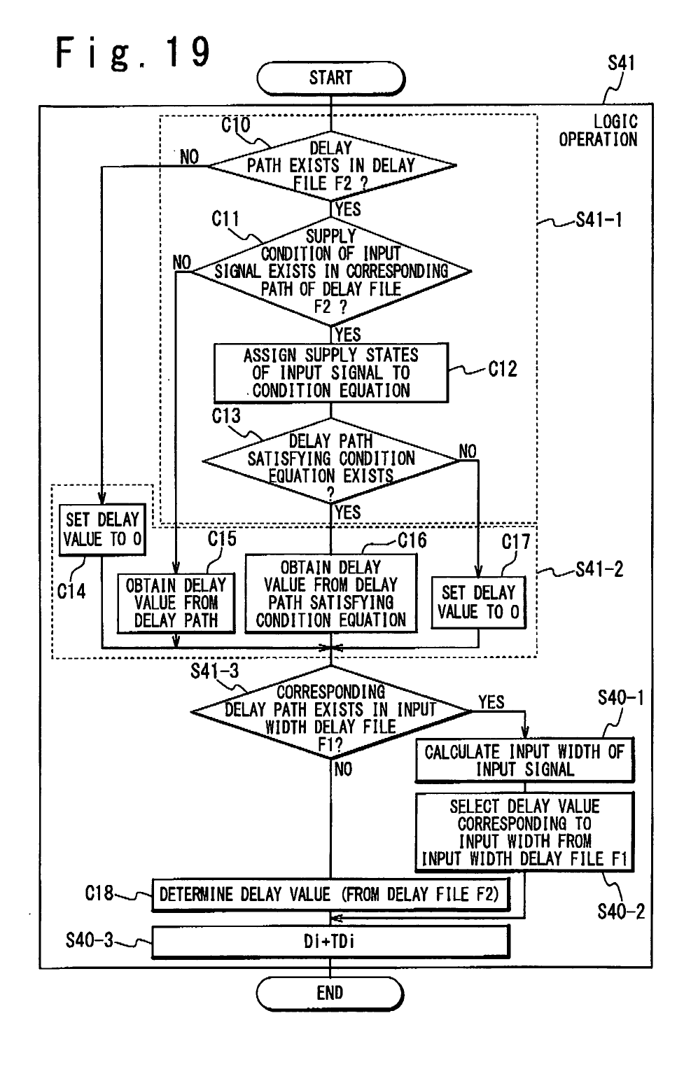

FIG. 19 is a diagram illustrating an operation of the logic operation part 232 (Step S41) of a second embodiment in more detail.

Details of the steps (Steps S41-1 and 541-2) in which the input signal supply check part 232-1 checks the supply state of the input signal at the input terminal and the element delay value selection part 232-2 selects the element delay value corresponding to the supply state of the input signal at the input terminal from the delay file F2 are described. The input signal is provided for the simulation from the logic description file 100.

The input signal supply check part 232-1 extracts the logic gate information (block name F11 or F21), the delay path information F12 or F22, the supply state of the input signal and the like from the event transmission part 220. Then, the input signal supply check part 232-1 refers to the delay file F2 corresponding to the supply state of the verification target input signal and the logic gate information (block name F21) to determine whether or not the corresponding delay path information F22 is present in the delay file F2 (Step C10). If the delay path information F22 is present, the input signal supply check part 232-1 performs Step C11. If the delay path information is not present, the element delay value selection part 232-2 selects 0 as the element delay value because of the absence of the element delay value to be obtained (Step C14). The input signal supply check part 232-1 checks the supply states of the input signals at all of the input terminals of the verification target logic gate. Then, the input signal supply check part 232-1 determines whether or not the supply state condition equation F23 is present in the delay file F2 having been referred to (Step C11). If the supply state condition equation F23 is present, the input signal supply check part 232-1 assigns to the supply state condition equation F23 in the selected delay file F2 each of the supply states of the plurality of input signals at the plurality of input terminals other than the input signal at the verification target input terminal among the plurality of input terminals included in the logic gate (Step C12) (L10, L11 in FIG. 15). If the supply state condition equation F23 is not present, the element delay value selection part 232-2 obtains the fixed element delay value information F24 and F25 defined in the delay path information from the delay file F2 having been referred to, and selects it as the element delay value (Step C15) (L12 in FIG. 15).

The element delay value selection part 232-2 assigns it to the supply state condition equation F23 (Step C12), and then determines whether or not the delay path information meeting the condition equation assigned with it is present (Step C13). If the delay path information is present, the element delay value selection part 232-2 obtains, on the basis of the corresponding delay path information, the fixed element delay value information F24 and F25 and selects it as the element delay value (Step C16). By assigning to the supply state condition equation F23 all of the supply states of each of the plurality of input signals at the plurality of input terminals other than the input signal at the verification target input terminal among the plurality of input terminals included in the logic gate, the element delay value selection part 232-2 selects 0 as the element delay value because the fixed element delay value information F24 or F25 to be obtained is absent if the corresponding delay path F22 is not present (Step C17).

After the fixed element delay value information corresponding to the supply state of the input signal at the input terminal has been selected from the delay file F2, the delay path information search part 232-3 determines whether or not the delay path information F12 corresponding to the input signal at the input terminal is present in the input width delay file F1 (Step S41-3). If the delay path information F12 is present, the input width calculation part 231-1 and element delay value determination part 231-2 calculate the mathematical formula information F14 or F15 representing the element delay value information on the basis of an input width from the input width delay file F1 similarly to a first embodiment, and obtains the element delay value (Steps S40-1 and S40-2). If the delay path information F12 is not present, the element delay value determination part 232-4 determines the value selected from the delay file F2 as the element delay value (Step C18).

In a second embodiment, the two pieces of delay information, i.e., the input width delay file F1 and the delay file F2 are provided with. Then, the element delay value can be obtained from each of them. That is, on the basis of two conditions, i.e., the supply state and the input width of the input signal, the logic simulation in which the plurality of different delay values are set can be performed. A highly accurate simulation capable of flexibly dealing with supply states of a plurality of input signals at a plurality of input terminals can be achieved in delay operations of an actual device.

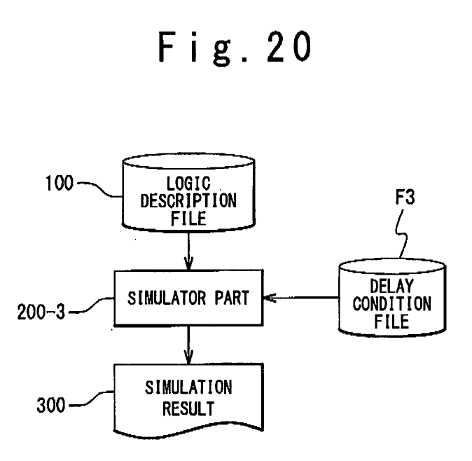

FIG. 20 is a block diagram illustrating a third embodiment of the present invention.

In a logic simulator of a third embodiment, the input width delay file F1 and delay file F2 of the logic simulator in a first or second embodiment is replaced by a delay condition file F3. In a third embodiment, a signal duration delay file associating a duration of an input signal and an element delay value with each other is referred to as the delay condition file F3. In a third embodiment, an element delay value is more simply determined on a basis of an input width and a supply state of an input signal at an input terminal.

The logic simulator of a third embodiment includes the logic description file 100, the delay condition file F3, the simulator part 200-3, and the simulation result 300. These components are stored in the storage device 20. Regarding the logic simulator of a third embodiment, the logic description file 100 and the simulation result 300 are configured in the same manner as in first and the second embodiments.

The logic description file 100 represents a logic description of a verification target logic circuit. The simulator part 200-3 extracts a logic description, a supply state of an input/output signal, a load capacitance and the like from the logic description file 100. The delay condition file F3 stores element delay value information based on input widths and supply states of a plurality of input signals at a plurality of input terminals. The simulator part 200-3 calculates an element delay value for each of a plurality of logic gates of the verification target logic circuit,.on the basis of the logic description, the supply state of the input/output signal at an input/output terminal, the load capacitance and the like provided from the logic description file 100, and the element delay value information provided from the delay condition file F3. Also, the simulator part 200-3 calculates an interconnection delay value on the basis of delay coefficient data corresponding to supply states of the plurality of input signals at the plurality of input terminals and a supply state of an output signal, and the load capacitance provided from the logic description file 100. As a method for obtaining the delay coefficient data, any of a method in which an external file of the simulator part 200-3 is referred to and a method in which the delay coefficient data is preliminary stored in the simulator part 200-3 can be adopted similarly to first and second embodiments. Further, the simulator part 200-3 sets a delay value (Di+TDi), which is obtained by summating the determined element delay value and interconnection delay value for information on the output signal at the output terminal to perform the logic simulation. The simulation result 300 stores therein a result of the simulation.

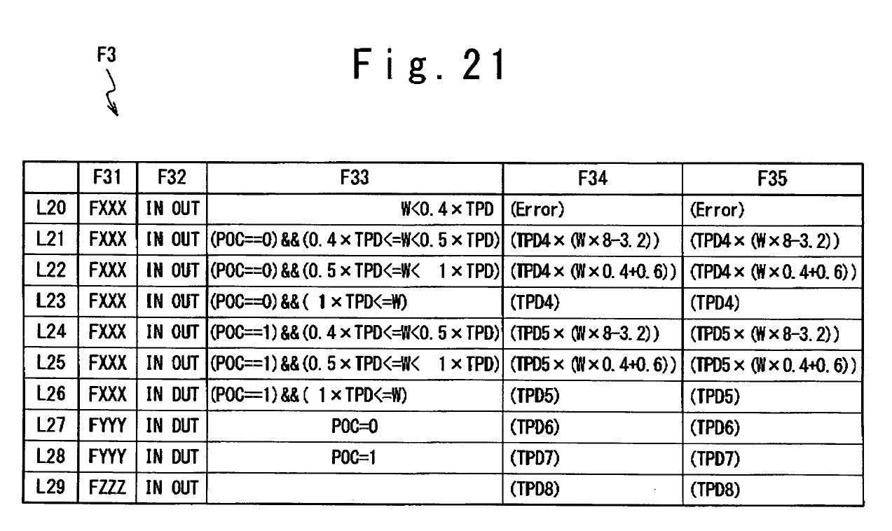

FIG. 21 is a configuration example of the delay condition file F3 in a third embodiment.

The delay condition file F3 is provided with a block name F31, delay path information F32, an input width and supply state condition equation F33, and mathematical formula information (including a fixed value) F34 and F35 representing element delay value information. The block name F31 represents the name of a logic gate of the verification target logic circuit. The delay path information F32 indicates which of input terminals at which a variation in the input signal determines an output variation at the output terminal. That is, the delay condition file F3 stores a plurality of logic gates (block name F31) and a plurality of pieces of delay path information F32. The input width and supply state condition equation F33 represents a condition under which a delay value is switched on the basis of the input width and the supply state of the input signal at an input terminal. As the supply state of the input signal, there are included the supply states of the plurality of input signals at the plurality of input terminals of the verification target logic gate. The mathematical formula information (including a fixed value) F34 and F35 representing the element delay value information stores an element delay value corresponding to the input width/supply state condition equation F33. The mathematical formula information (including a fixed value) F34 and F35 representing the element delay value information is set for the information on an output signal at the output terminal when the logic simulation is performed.

TPD4 to TPD8 shown in the mathematical formula information (including a fixed value) F34 and F35 indicating the element delay value information respectively represents different pieces of fixed delay value information. If similarly to the block diagram of FIG. 16, there is an input terminal POC, which is not directly relevant to logic, L21, L22, and L23 represent element delay values for a case where the signal state of the input terminal POC is 0. L24, L25, and L26 represent element delay values for a case where the signal state of the input terminal POC is 1. That is, L21 to L23 and L24 to L26 enable the element delay values corresponding to the input width of an input signal to be calculated, and include influence of the input terminal not directly relevant to logic on the element delay value. Regarding L20, the input width is short and therefore the mathematical formula information (including a fixed value) F34 and F35 representing the element delay value information indicates Error; however, the influence of the input terminal POC not directly relevant to the logic is taken into account. That is, in a third embodiment, it is possible to perform a more accurate simulation by taking into account each of supply states of a plurality of input signals at a plurality of input terminals other than an input signal at a verification target input terminal among input terminals included in the logic gate. Each of L27 and L28 has no input width range information, and represents a description for a case where supply states of input signals at an input terminal and the input terminal not directly relevant to logic are provided. L29 represents a description for a case where a supply state of an input signal at the verification target input terminal is only provided. From the above, it is possible to represent the delay operation of the input width delay file F1 and delay file F2 by the delay condition file F3.

Regarding the simulator part 200-3, the logic operation part 231 and 232 in the simulator part 200-1 and 200-2 is replaced by the logic operation part 233. The rest is the same as that of the configuration in FIG. 10.

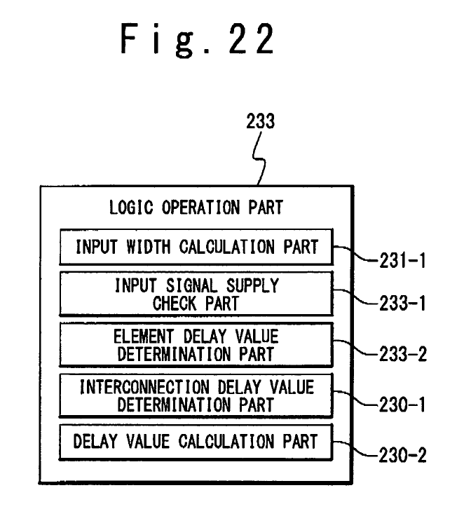

FIG. 22 is a diagram illustrating a configuration of the logic operation part 233.

The logic operation part 233 is provided with an input width calculation part 231-1, an input signal supply check part 233-1, an element delay value determination part 233-2, an interconnection delay value determination part 230-1, and a delay value calculation part 230-2.

The input width calculation part 231-1 calculates an input width on the basis of an input signal at an input terminal of the verification target logic gate. The input signal supply check part 233-1 checks supply states of input signals at all input terminals of the verification target logic gate on the basis of logic gate information, delay path information and the like provided from the event transmission part 220. Also, the input signal supply check part 233-1 refers to the delay condition file F3 corresponding to the supply state of the verification target input signal. The element delay value determination part 233-2 determines, from the input width delay file F3 having been referred to, an element delay value based on the input width and the supply state of the input signal at the input terminal. The interconnection delay value determination part 230-1 calculates an interconnection delay value in the same manner as those of first and the second embodiments. The delay value calculation part 230-2 summates the determined element delay value and interconnection delay value to calculate the delay value.

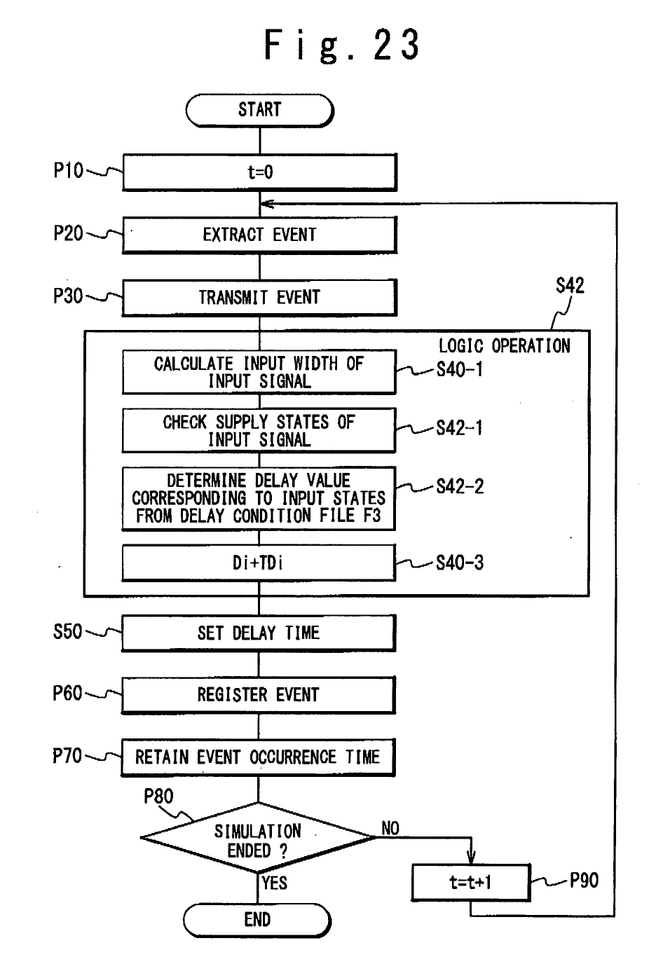

FIG. 23 is a flowchart illustrating a processing operation of the logic simulator of a third embodiment of the present invention. As compared with first and the second embodiments, the logic operation part 233 (Step S42) is changed. The rest is the same as those in first and the second embodiments. An input signal is provided for the simulation from the logic description file 100. The event transmission part 220 transmits an extracted event (Step P30). Information on the transmission is included in the logic description file 100. The event transmission part 220 provides logic gate information, delay path information and the like associated with the simulation to the logic operation part 233 on the basis of the logic description file 100.

The logic operation part 233 determines a delay value for each logic gate (Step S42). The input signal calculation part 231-1 calculates the input width on the basis of the input signal (Step S40-1). The input signal supply check part 233-1 checks supply states of input signals at all input terminals of the verification target logic gate (Step S42-1). The delay condition file F3 corresponding to a supply state of the verification target input signal, logic gate information (block name F31), delay path information F32, and an input width/supply state condition equation F33 is referred to. The element delay value determination part 233-2 selects mathematical formula information (including a fixed value) F34 and F35 representing element delay value information on the basis of the delay condition file F3 being referred (Step S42-2). If an input width W has not been calculated, fixed element delay value information based on the supply state of the input signal at the verification target input terminal is selected (L27 to L29 in FIG. 21). Then, the fixed element delay value information corresponding to the supply states of the plurality of input signals at the above-described input terminal (POC) is determined (L27, L28 in FIG. 21). Also, if there is no condition for the above-described input terminal (POC), the fixed element delay value information is determined from the supply state of the verification target input signal (L29 in FIG. 21). The delay value calculation part 230-2 summates the element delay value determined on the basis of the delay condition file F3 and the interconnection delay value determined in the interconnection delay value determination part 230-1 (Step S40-3). The subsequent operation is the same as those in first and the second embodiments.

The delay condition file F3 produces an effect of simultaneously using pieces of content of the input width delay file F1 and the delay file F2. In a third embodiment, it is possible to perform two methods by using one file, one is the method in which the element delay value is set on the basis of the input width of the input signal at the verification target input terminal, and the other is the method in which the element delay value is set on the basis of the supply state of the input signal at the verification target input terminal. Further in a third embodiment, with such two methods, it is also possible to take into account the influence of each of supply states of a plurality of input signals at a plurality of input terminals other than the input signal at the verification target input terminal among input terminals included in the logic gate. That is, a third embodiment has both of the effects of first and second embodiments, and enables the logic simulation to be further simply and accurately performed. Also, in a third embodiment, processing for creating the two files, i.e., the input width delay file F1 and the delay file F2, is reduced by putting them together into one. Accordingly, processing steps for obtaining an element delay value from both of the input width delay file F1 and the delay file F2 upon performance of the logic simulation are put together into one, and therefore an effect of reducing the man-hour for development can also be obtained.

As described in first to third embodiments, in the present invention, it is possible to set a delay value even its input width is small, and a highly accurate logic simulation can be achieved. The present invention can also deal with a signal having a small operational frequency input width as compared with the patent document 1 so that it is possible to set a high operational frequency on a test pattern.

Although the present invention has been described above in connection with several embodiments thereof, it would be apparent to those skilled in the art that those embodiments are provided solely for illustrating the present invention, and should not be relied upon to construe the appended claims in a limiting sense.

What is claimed is:

1. A logic simulator comprising:
a storage device configured to store a signal duration delay file which associates first signal duration information indicating duration of an input signal supplied to a logic gate of a logic circuit with first element delay value information indicating a first element delay value; and
a simulator part configured to extract first element delay value information associated with the first signal duration information corresponding to second signal duration information indicating duration of an input signal supplied to the logic gate when a logic simulation is performed by referring the signal duration delay file, and perform the logic simulation of the logic circuit based on the extracted first element delay value information.

2. The logic simulator according to claim 1, wherein in the signal duration delay file, the first signal duration information includes range information indicating a range of duration, and the first element delay value information includes a mathematical formula information indicating a mathematical formula for calculating the first element delay value based on the range information and the second signal duration information.

3. The logic simulator according to claim 2, wherein the signal duration delay file stores logic gate information specifying the logic gate and delay path information specifying which variation of input signal influences a variation of an output signal of the logic gate which are associated with the first signal duration information and the first element delay value information, and
the range information and the mathematical formula information are determined based on the logic gate information and the delay path information.

4. The logic simulator according to claim 1, wherein the storage device further stores a supply state delay file which associates supply state information indicating a supply state of an input signal supplied to the logic gate with second element delay information indicating a second element delay value, and
in the supply state delay file, the supply state information includes adjacent supply state information indicating supply state of an input signal of each of input terminals other than an input signal at a verification target input terminal among a plurality of input terminals included in the logic gate.

5. The logic simulator according to claim 4, wherein the supply state indicates a voltage of an input signal.

6. The logic simulator according to claim 1, wherein the signal duration delay file stores supply state information indicating a supply state of an input signal supplied to the logic gate associated with second element value information indicating a second element delay value, and further stores adjacent supply state information indicating supply state of an input signal of each of input terminals other than an input signal at a verification target input terminal among a plurality of input terminals included in the logic gate associated with the first signal duration information and the first element delay value information and the second element delay value.

7. The logic simulator according to claim 6, wherein the supply state indicates a voltage of an input signal.

8. A logic simulation method comprising:
generating signal duration delay file which associates first signal duration information indicating duration of an input signal supplied to a logic gate of a logic circuit with first element delay value information indicating a first element delay value;
extracting first element delay value information associated with the first signal duration information corresponding to second signal duration information indicating duration of an input signal supplied to the logic gate when a logic simulation is performed by referring the signal duration delay file; and
performing the logic simulation of the logic circuit based on the extracted first element delay value information.

9. The logic simulation method according to claim 8, wherein the first signal duration information includes range information indicating a range of duration, and the first element delay value information includes a mathematical formula information indicating a mathematical formula for calculating the first element delay value based on the range information and the second signal duration information.

10. The logic simulation method according to claim 9, wherein the signal duration delay file stores logic gate information specifying the logic gate and delay path information specifying which variation of input signal influences a variation of an output signal of the logic gate which are associated with the first signal duration information and the first element delay value information, and
the range information and the mathematical formula information are determined based on the logic gate information and the delay path information.

11. The logic simulation method according to claim 8, further comprising:
generating a supply state delay file which associates supply state information indicating a supply state of an input signal supplied to the logic gate with second element delay information indicating a second element delay value,
wherein in the supply state delay file, the supply state information includes adjacent supply state information indicating supply state of an input signal of each of input terminals other than an input signal at a verification target input terminal among a plurality of input terminals included in the logic gate.

12. The logic simulation method according to claim 11, wherein the supply state indicates a voltage of an input signal.

13. The logic simulation method according to claim 8, further comprising:
associating supply state information indicating a supply state of an input signal supplied to the logic gate with second element value information indicating a second element delay value, and
generating adjacent supply state information indicating supply state of an input signal of each of input terminals other than an input signal at a verification target input terminal among a plurality of input terminals included in the logic gate associated with the first signal duration information and the first element delay value information and the second element delay value.

14. The logic simulation method according to claim 13, wherein the supply state indicates a voltage of an input signal.

15. A computer program product embodied on a computer-readable medium and comprising code that, when executed, causes a computer to perform the logic simulation method according to claim 8.
